(19) United States
(12) Patent Application Publication
(10) Pub. No.: US 2019/0275608 A1
(43) Pub. Date: Sep. 12, 2019

(54) COMPONENTS AND SYSTEMS FOR FRICTION STIR WELDING AND RELATED PROCESSES

(71) Applicant: Novelis Inc., Atlanta, GA (US)

(72) Inventors: Sazol Kumar Das, Acworth, GA (US); Hany Ahmed, Atlanta, GA (US); Ganesh Bhaskaran, Kennesaw, GA (US)

(73) Assignee: Novelis Inc., Atlanta, GA (US)

(21) Appl. No.: 16/423,757

(22) Filed: May 28, 2019

Related U.S. Application Data
(62) Division of application No. 15/496,047, filed on Apr. 25, 2017.
(60) Provisional application No. 62/377,721, filed on Aug. 22, 2016.

(51) Int. Cl. B23K 20/12; B23K 20/26

(52) U.S. Cl. CPC B23K 20/1255; B23K 20/1265; B23K 2103/18; B23K 20/26; B23K 20/126; B23K 20/122

(57) ABSTRACT

Described herein are tools and systems for friction stir welding, including cooling and clamping systems. Also disclosed are process parameters for friction stir welding aluminum metals, in some cases thick gauge aluminum metals, to other metals. The tool and process parameters can be used in transportation, electronics, industrial and motor vehicle applications, just to name a few.

### CROSS REFERENCE TO RELATED APPLICATION

The present application is a division of U.S. application Ser. No. 15/496,047 filed Apr. 25, 2017, which claims the benefit of U.S. Provisional Patent Application No. 62/377,721 filed Aug. 22, 2016, which are hereby incorporated by reference in their entireties.

### FIELD OF THE INVENTION

The present invention relates to metal welding, in particular friction stir welding.

### BACKGROUND

Friction stir welding (referred to as “FSW”) is a method of joining a first metal, such as an aluminum alloy sheet or plate, to a second metal, such as a steel, copper, nickel or other metal sheet or plate. The sheets/plates are softened, but not melted, and the softened metals and/or alloys are mechanically mixed by stirring and joined by applying pressure from a FSW tool to interlock the metal sheets or plates.

Aluminum alloys are increasingly replacing steel and other metals in manufacturing and various applications. Increased use of aluminum alloys requires a broader range of characteristics of the aluminum alloy parts, such as thicker gauges. Joining aluminum alloys with steel or other metals is challenging, especially when joining thicker gauges.

### SUMMARY

The terms “invention,” “the invention,” “this invention” and “the present invention,” as used in this document, are intended to refer broadly to all of the subject matter of this patent application and the claims below. Statements containing these terms should be understood not to limit the subject matter described herein or to limit the meaning or scope of the patent claims below. Covered embodiments of the invention are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

Provided herein is a tool for FSW thick gauge, dissimilar and/or other metal sheets (i.e., 3.5-8 mm) and plates (i.e., 8-16 mm) such as, but not limited to, aluminum alloy and steel, copper, nickel or other metal sheets and plates. As used herein, the term metal includes alloys. In some cases, the FSW tool includes a pin having a plurality of planar surfaces separated from one another by a plurality of teeth. In some cases, the tip of the pin is curved/domed. The pin extends from a shoulder, which may be concave in some examples. In some cases, a diameter of the shoulder is increased relative to a length of the pin. For example, a ratio of the diameter of the shoulder relative to the length of the pin may be greater than approximately 2.5:1, such as but not limited to approximately 3:1 or approximately 3.5:1.

Also disclosed are systems and methods for reducing heat generated in FSW. In some cases, a heat sink, such as but not limited to a copper anvil, and/or cooling nozzles are used. In some cases, the system additionally or alternatively includes clamps to help maintain the position of the metals during FSW.

Moreover, methods of welding dissimilar metals, including thick gauge metals, without defects or with minimized defects are disclosed. In some cases, the methods result in a FSW joint with layered intermetallic mixing and strong interlocking without forming a thicker (e.g., <2 μm) intermetallic layer at the interface.

### BRIEF DESCRIPTION OF THE FIGURES

FIG. 1 is a perspective view of a FSW tool according to one example.

FIG. 2 is a schematic side view of the tool of FIG. 1, shown inserted into two metals.

FIG. 3 is a top perspective view of an assembly for FSW according to one example.

FIG. 4 is a digital image of weld flash generated during FSW.

FIG. 5 is a top perspective view of an assembly for FSW according to another example.

FIG. 6 is a close-up side perspective view of a cooling nozzle of a system for FSW according to one example.

FIG. 7 is a digital image of a metal plate with a reduced thickness area according to an example.

FIG. 8 is a digital image of a deformed metal plate according to one example.

FIG. 9 is a scanning electron microscope (SEM) image of a weld formed according to an exemplary method.

FIG. 10 is a graph of bond strength of a friction stir weld compared with a 6xxx aluminum alloy and steel.

FIG. 11 is a digital image of a deformed FSW tool.

FIG. 12 is an SEM image of friction stir welded aluminum alloy and steel.

FIG. 13 is a digital image of friction stir welded aluminum alloy and steel.

FIG. 14 is an SEM image of friction stir welded aluminum alloy and steel.

FIG. 15 is a digital image of friction stir welded aluminum alloy and steel in butt configuration.

FIGS. 16A-C contain SEM images of friction stir welded aluminum alloy and steel. FIG. 16A is a low magnification image and FIGS. 16B and 16C are high magnification images.

FIGS. 17A-C contain SEM images of friction stir welded aluminum alloy and steel. FIG. 17A is a low magnification image and FIGS. 17B and 17C are high magnification images.

FIG. 18 is a graph illustrating the hardness of various welds.

FIG. 19 is a graph of tensile strength of FSW work pieces before and after corroding.

FIG. 20 is a graph of tensile strength of FSW work pieces in a butt weld configuration.

FIGS. 21A-B are digital images of corroded FSW work pieces.

FIGS. 22A-B are digital images of corroded FSW work pieces.

FIG. 23 is a graph of bond strength of FSW work pieces after corrosion testing.

FIGS. 24A-B are digital images of corroded FSW workpieces.

FIGS. 25A-B are digital images of corroded FSW workpieces.

FIGS. 26A-B are schematic drawings of products achievable according to methods and aluminum alloys described herein.

### DETAILED DESCRIPTION

### Definitions and Descriptions

The terms “invention,” “the invention,” “this invention” and “the present invention” used herein are intended to refer broadly to all of the subject matter of this patent application and the claims below. Statements containing these terms should be understood not to limit the subject matter described herein or to limit the meaning or scope of the patent claims below.

### AA Designations

In this description, reference is made to alloys identified by aluminum industry designations, such as “series” or “6xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, the meaning of “a,” “an,” or “the” includes singular and plural references unless the context clearly dictates otherwise.

Disclosed is a tool for friction stir welding (FSW) two sheets, plates or other pieces of metal. In some cases, one or both of the metals is a thick gauge (e.g., about 5-10 mm) aluminum alloy, although in other cases one or both of the metals is not a thick gauge. In some cases, the second metal is a different metal, such as steel, copper, nickel or other metal. In some cases, the second metal has a different thickness than the first metal; in some cases, the second metal is thinner than the first metal. The first and second metals are friction stir welded to form a weld of any suitable configuration, including lap, edge, butt, T-butt, hem, T-edge, etc.

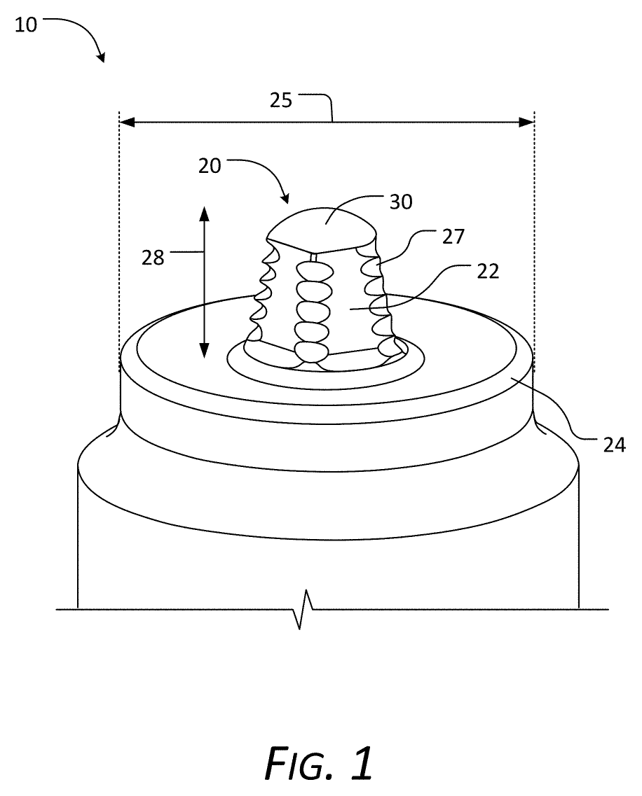

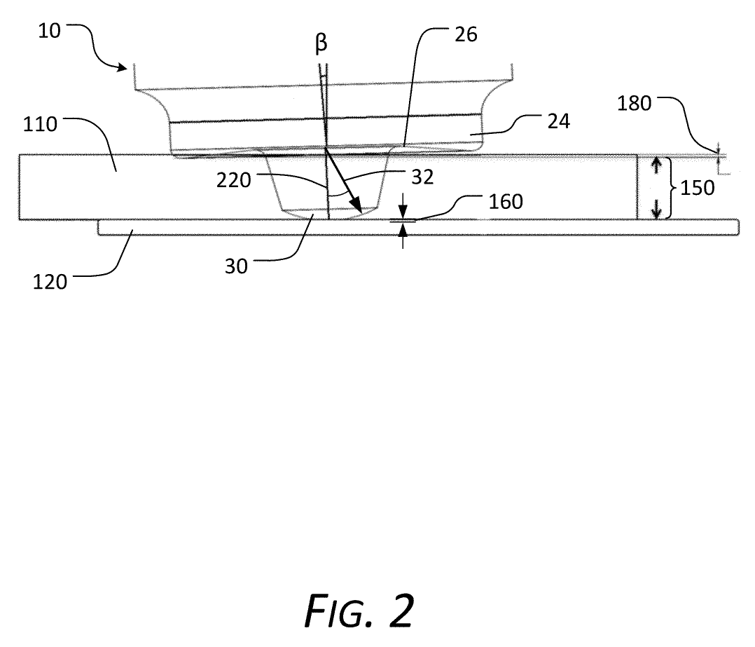

FIG. 1 is a perspective view of a tool 10 according to one example. The tool 10 includes a pin 20 that extends from a shoulder 24. In some cases, as seen in FIG. 2, shoulder 24 has a concave surface 26 with a concavity of between approximately 10° and approximately 30°, such as but not limited to between approximately 15° and approximately 20° or between approximately 10° and approximately 15°. The concave surface 26 can reduce flashing during FSW and also act as a material reservoir. Shoulder 24 can have any suitable diameter 25 (FIG. 1). In some non-limiting examples, the diameter 25 of the shoulder 24 is between approximately 15 mm and 25 mm, such as but not limited to between approximately 17 mm and approximately 22 mm or between approximately 19 mm and approximately 21 mm. Pin 20 includes a plurality of planar or generally planar sides 22 separated from one another by threads 27. In the non-limiting example shown in FIG. 1, pin 20 includes five planar or generally planar sides 22 and five sets of threads 27. In some cases, a pin having five (or other suitable number of) planar sides provides improved eccentricity during FSW.

Pin 20 can have any suitable length 28. In some non-limiting examples, the length 28 of the pin 20 is between approximately 5 mm and approximately 11 mm, such as but not limited to between approximately 6 mm and approximately 9 mm or between approximately 5.9 mm and approximately 9.8 mm. Pin 20 includes a tip 30 that can be domed/curved. The dome shape of the tip 30 can help improve the life of the tool 10. The domed tip 30 can also increase the surface area and provide more contact with the metal work piece, which can result in an improved interlock between the metals being welded. Tip 30 can have any radius 32 (see FIG. 2), including between approximately 5 mm and approximately 10 mm, depending on the aluminum plate thickness to be welded.

In some non-limiting examples, the ratio of the diameter 25 of the shoulder 24 to the length 28 of the pin 20 is increased from conventional tools. For example, the ratio of the diameter 25 to the length 28 may be greater than 2.5:1, such as but not limited to approximately 3:1 or approximately 3.5:1, which may reduce heat generated during FSW.

FIG. 2 is a schematic of the tool 10 inserted into a first metal plate 110 positioned on top of a second metal plate 120. Plates 110, 120 may have the same or different thicknesses. In one non-limiting example, first metal plate 110 is a heated aluminum alloy plate and second metal plate 120 is a heated steel plate. In one non-limiting example, first metal plate 110 has a thickness of between approximately 5 and 10 mm, while second metal plate 120 has a thickness of approximately 2 mm, although each of plates 110 and 120 may have any suitable thickness.

Pin 20 penetrates the first metal plate 110 by depth 150 and penetrates the second metal plate 120 by a depth 160. In some cases, depth 150 generally corresponds to the thickness of the first metal plate 110. In the example illustrated in FIG. 2, depth 150 is between approximately 5 mm and approximately 10 mm. Depth 160 can be any suitable depth including, for example, between approximately 0.05 mm and approximately 0.15 mm, such as but not limited to between approximately 0.07 mm and approximately 0.12 mm or between approximately 0.08 mm and approximately 0.10 mm. Shoulder 24 of tool 10 plunges into the first metal plate 110 at any suitable depth 180, such as for example, between approximately 0.05 mm and approximately 0.15 mm, such as but not limited to between approximately 0.07 mm and approximately 0.12 mm or between approximately 0.08 mm and approximately 0.10 mm. The plunge depth 180 of the shoulder 24 directly relates to the degree of curvature of the concave surface 26.

In some examples, as shown in FIG. 2, tool 10 is tilted at an angle β relative to a vertical axis 220, where β is between approximately 1° and approximately 4°, such as between approximately 1° and approximately 3°, or between approximately 1.5° and approximately 2.5°.

Tool 10 can be made of any suitable material such as steel. Two non-limiting examples of compositions of tool 10 are illustrated in Table 1 below, although any suitable material may be used.

TABLE 1

| Tool | | | | | | | | | | Hardness |
|---|---|---|---|---|---|---|---|---|---|---|
| Steel | C | Mn | Si | Cr | W | Mo | V | Co | Fe | (HRC) |
| H13 | 0.40 | 0.40 | 1.00 | 5.25 | 0 | 1.35 | 1.00 | 0 | Remainder | 42 |
| M42 | 1.08 | 0 | 0.45 | 3.85 | 1.50 | 9.50 | 1.20 | 8.00 | Remainder | 68-70 |

As mentioned above, first and second metal plates 110, 120 can be any suitable material. In one example, first metal plate 110 is an aluminum alloy while second metal plate 120 is steel. Table 2 below lists two non-limiting examples of the composition of first metal plate 110, although any suitable aluminum alloy may be used, including any 2xxx, 5xxx, or 6xxx series aluminum alloy. As one non-limiting example, second metal plate 120 may be AISI 1018.

TABLE 2

| | | | | | | | | | Impurities | | |
|---|---|---|---|---|---|---|---|---|---|---|---|
| Alloy | Si | Fe | Cu | Mn | Mg | Cr | Zn | Ti | Each | Total | Al |
| 5xxx | 0.1-0.5 | 0.25-0.40 | 0.05-0.20 | 0.1-1.0 | 2.2-5.0 | 0.05-0.30 | 0.02-0.3 | 0.02-0.2 | 0.05 | 0.15 | Remainder |
| 6xxx | 0.5-1.2 | 0.18-0.26 | 0.1-1.0 | 0.07-0.2 | 0.6-1.5 | 0.02-0.1 | 0.01-0.5 | 0.01-0.2 | 0.05 | 0.15 | Remainder |

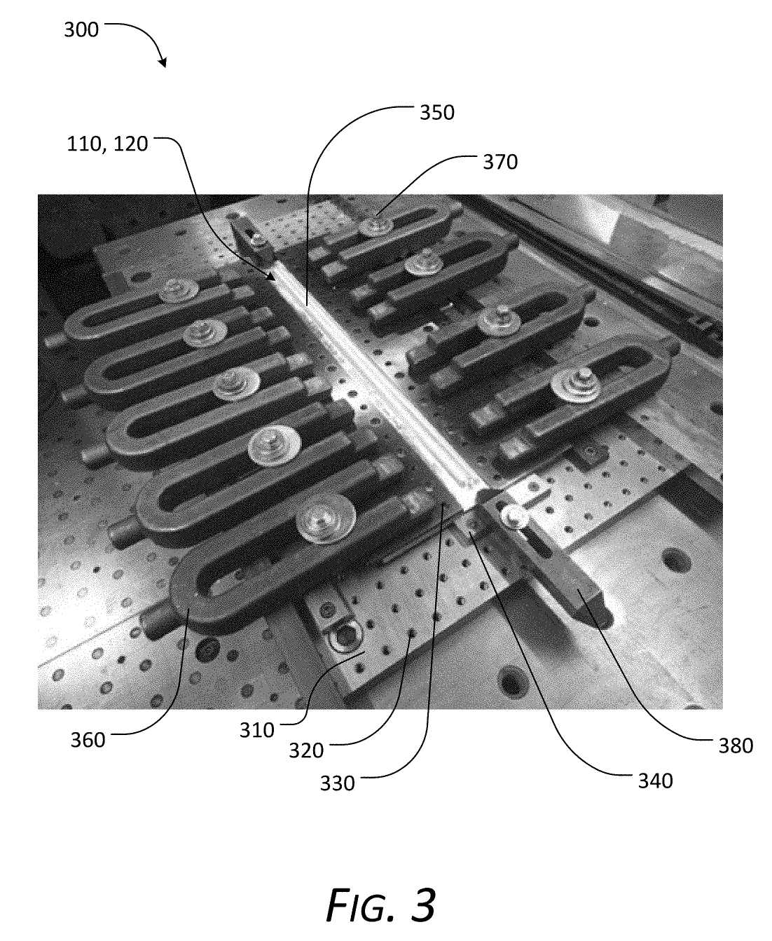

FIG. 3 illustrates a clamping system 300 that may be used to clamp the first and second metal plates 110, 120 to secure the metal plates as the tool 10 or other suitable tool traverses along a weld path 350 during FSW. The first and second metal plates 110, 120 are positioned on a FSW fixture surface 310. In some non-limiting examples, first and second metal plates 110 and 120 (second metal plate 120 is obscured in this image) are placed between two hardened metal pieces 330, which may be steel or any other suitable metal, such that each longitudinal side of the first and second metal plates 110, 120 contacts one of the metal pieces 330. To ensure and maintain alignment of the first and second metal plates 110 and 120 relative to metal pieces 330, an end stop 340 may be positioned to abut at least a portion of one or both ends of the first and second metal plates 110 and 120 and at least a portion of one or both ends of the metal pieces 330. A plurality of clamps 360, which may be toe clamps or any suitable type of clamp, overlap the metal pieces 330 and are secured to the fixture surface 310 in any suitable manner, such as for example by driving washer-fitted bolts 370 into threaded holes 320 of the fixture surface 310. Clamps 360 may be spaced apart from one another, such as by approximately 25 mm or any other suitable distance.

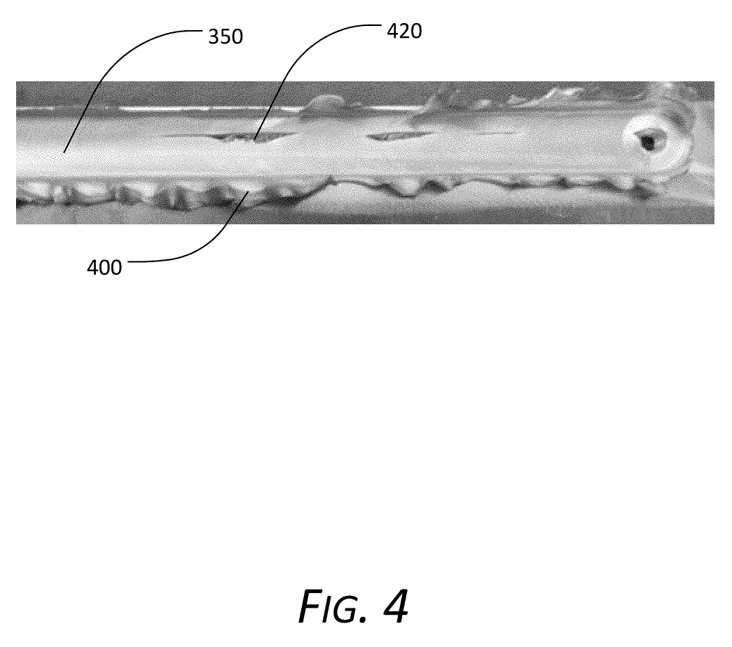

In some examples, clamping system 300 also includes end clamps 380 that secure the ends of the first and second metal plates 110 and 120 and, in some cases, the end stops 340. As with clamps 360, clamps 380 may be secured in any suitable way, including by bolting them to the fixture 310 by driving washer-fitted bolts 370 into the threaded holes 320. In some cases, end clamps 380 are not used. Utilizing a clamping system 300 with clamps 360 and/or clamps 380 helps secure the first and second metal plates 110 and 120 against the surface on which they are positioned, such as fixture surface 310. By preventing the first and second metal plates 110, 120 from lifting from the fixture surface 310, weld flash 400 as shown in FIG. 4 can be prevented or reduced. Utilizing a clamping system such as clamping system 300 may also prevent the first and second metal plates 110, 120 from warping after FSW.

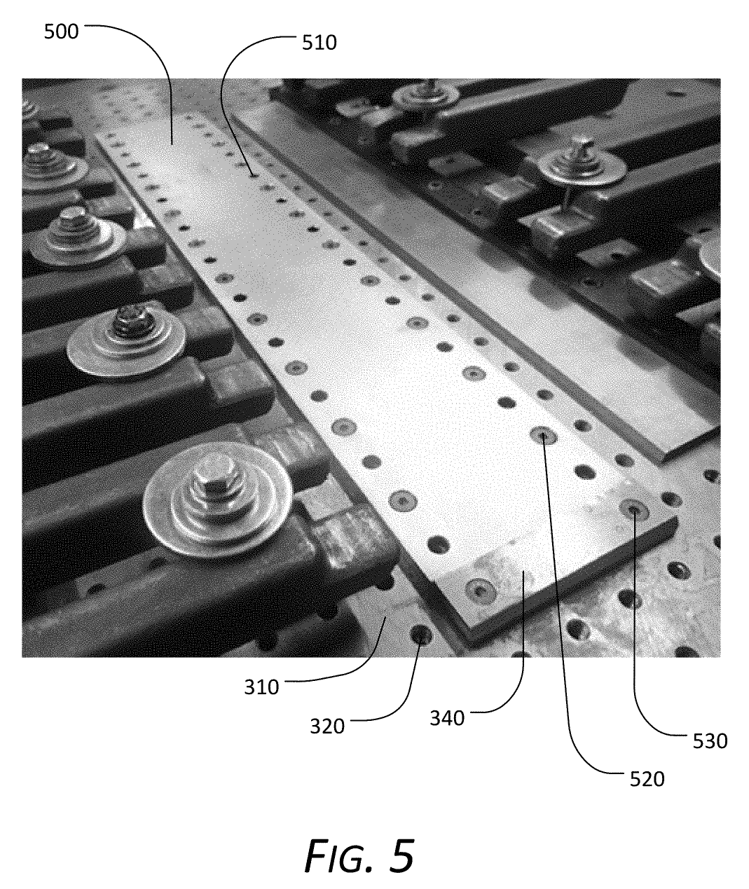

In some cases, the FSW system includes a heat sink or other heat transfer component, such as anvil 500 illustrated in FIG. 5. Anvil 500 may be copper or any suitable material for transferring heat. In some cases, anvil 500 includes a plurality of holes 510 for securing the anvil 500 to a surface, such as fixture surface 310, via the threaded holes 320 of the fixture surface 310, although anvil 500 may be secured in any suitable manner. As illustrated in FIG. 5, end stop 340 may be positioned to abut anvil 500. The first and second plates 110, 120 are positioned on top of anvil 500 and may be secured using the clamping system 300 described above or otherwise. As shown in FIG. 5, second plate 120 is positioned directly on top of anvil 500. In some non-limiting examples, anvil 500 acts as a heat sink to promote cooling of the first and second metal plates 110, 120 during FSW to reduce or eliminate warping, deformation and/or de-bonding of the first and second metal plates 110, 120 after the FSW. This is particularly beneficial when first and second metal plates 110, 120 are dissimilar materials like aluminum and steel, as aluminum and steel have significantly different coefficients of thermal expansion and thus the heat generated during FSW can result in severe warping.

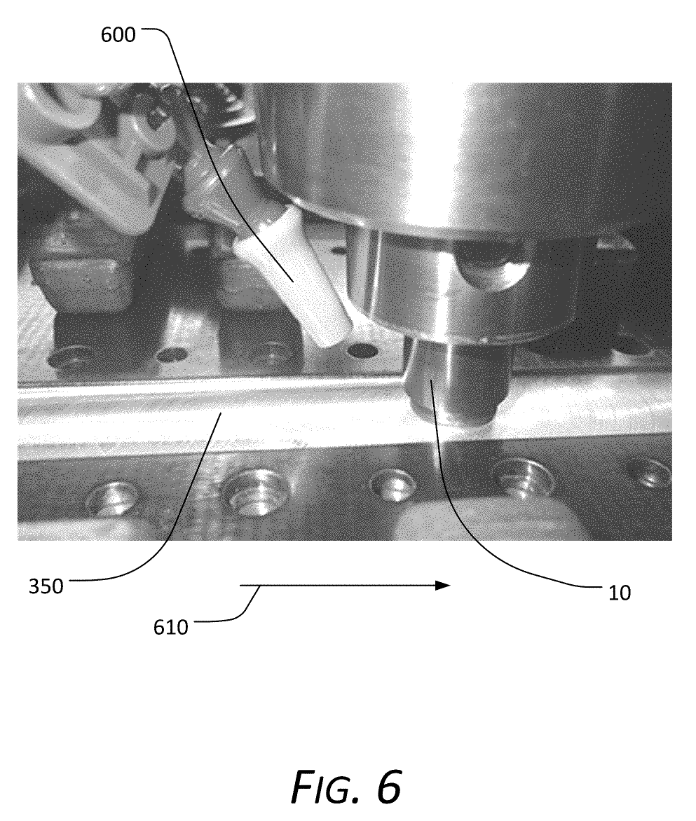

Also disclosed is a cooling system for controlling heat flow during FSW. FIG. 6 illustrates an exemplary cooling media delivery nozzle 600. Nozzle 600 is positioned adjacent to the FSW tool, for example tool 10, such that nozzle 600 follows the tool 10 as the tool 10 traverses along the first and second metal plates 110, 120 in direction 610. The cooling system can include one or more nozzles 600 that each deliver cooling media, such as liquid or gas, along a weld path 350, trailing the FSW tool 10 to remove heat generated in the first and second metal plates 110, 120. In some non-limiting examples, the cooling media is forced air and/or water (in some cases in the form of mist). Forced air can flow at a rate of about 5 L/min to about 20 L/min (for example between approximately 10 L/min and approximately 15 L/min). Delivering a cooling media to the weld path 350 adjacent the FSW tool 10 can prevent warping, deformation and/or de-bonding of the welded plates 110, 120 after the FSW.

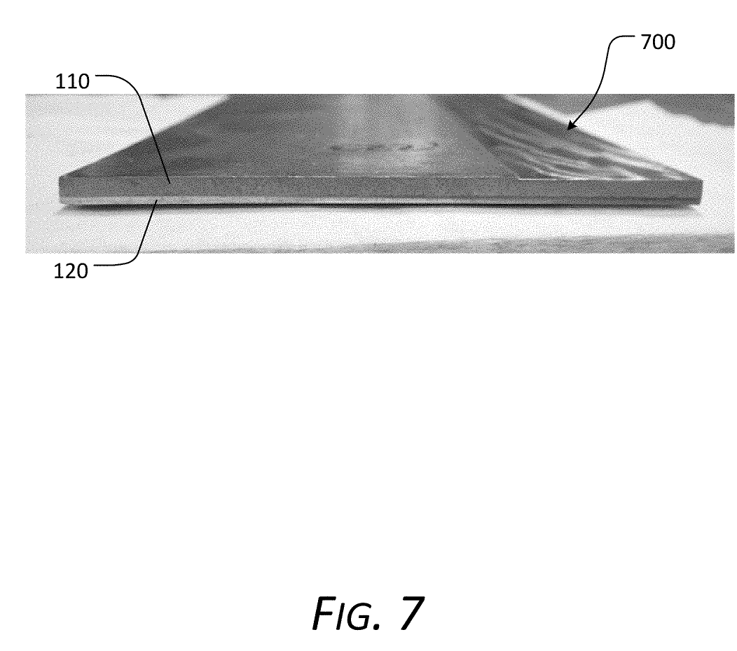

In some cases, one or both of first and second metal plates 110, 120 can be modified to have a reduced thickness area 700 as shown in FIG. 7. The reduced thickness area 700 corresponds to the weld path 350 (FIGS. 3 and 6). In some non-limiting examples, the thickness of the first metal plate 110 is reduced by approximately 0.05 mm to approximately 0.50 mm, for example approximately 0.21 mm. Reducing the plate thickness will result in flexibility to adjust the plunge depth and can help prevent or reduce the occurrence of weld flash 400 (FIG. 4) after the FSW.

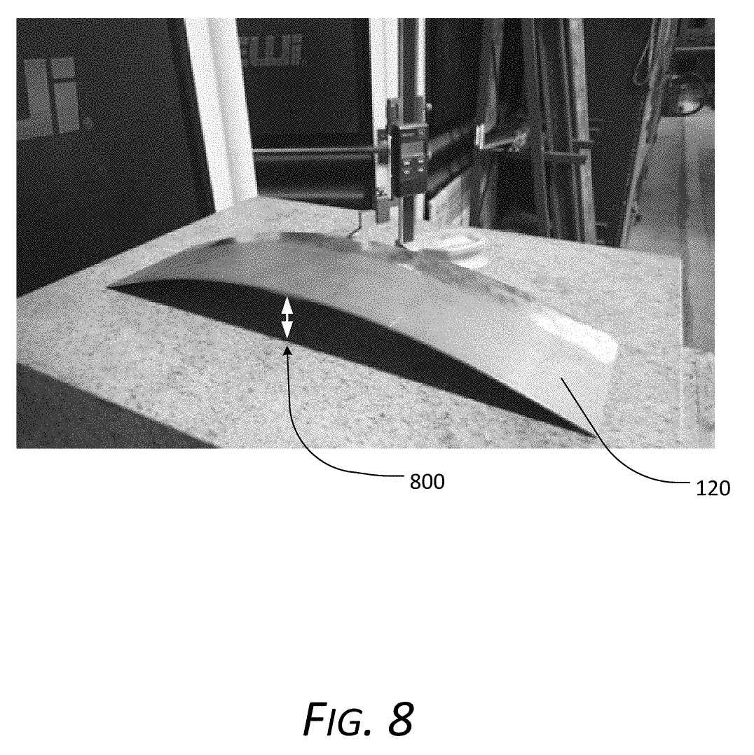

FIG. 8 illustrates a plate, such as plate 120, that has been pre-stressed prior to FSW. Pre-stressing one or both of first and second metal plates 110, 120 results in a warped or deformed plate as shown in FIG. 8. The warping 800 of one or both of first and second metal plates 110, 120 can extend from the original plane by approximately 1 mm to approximately 100 mm, for example, approximately 38 mm. In some non-limiting examples, the second metal plate 120 is pre-stressed before FSW. Pre-stressing one or both of first and second metal plates 110, 120 can provide a deformed plate that negates such warping that can occur after FSW.

Also disclosed are methods and processes for FSW. In some cases, as described above, the FSW joins plates (or sheets and/or other pieces) of dissimilar metals and/or having different thicknesses. The process parameters disclosed herein provide a suitable weld between plates, including one or more thick plates (e.g., about 5 mm-about 10 mm), without jeopardizing the mechanical and/or corrosion properties of the plates 110, 120. As mentioned above, in some cases, first metal plate 110 may be a high strength 2xxx, 5xxx, or 6xxx aluminum alloy while the second plate 120 may be steel.

If desired, one or both of first and second metal plates 110, 120 may be prepared prior to FSW. For example, first and/or second metal plate 110, 120 may be cleaned by an abrasive pad and/or a solvent. In some non-limiting examples, an abrasive pad comprises metal, alloy, glass, diamond, polymer, natural sponge or the like. In some non-limiting examples, a solvent is organic. In some further non-limiting examples, a solvent acts as a degreaser. In some non-limiting examples, a solvent includes acetone, isopropanol, ethanol, methanol, hexanes, chloroform, chlorobenzene or the like.

Once the first and/or second metal plates 110, 120 are prepared, they are positioned with respect to one another. In one non-limiting example, the first metal plate 110 overlaps the second metal plate 120 by approximately 25 mm, although the plates may have any suitable overlap. Once the first and second metal plates 110, 120 have been positioned as desired, the plates 110, 120 are friction stir welded together using a FSW tool such as tool 10 described above. Any one or more of clamping system 300, heat sink 500, and cooling nozzles 600 may be employed during FSW.

In particular, a pin (such as pin 20) of the FSW tool (such as tool 10) is inserted into the first metal plate 110 at a plunge depth 150 (see FIG. 2) with a desired initial axial force and initial rotational speed. In one example, the initial axial force is between approximately 7-25 kN, such as between approximately 10-22 kN, or between approximately 15-21 kN, and the initial rotational speed is between approximately 50-150 RPM, such as approximately 70-120 RPM or approximately 80-100 RPM. The tool 10 is inserted through an entire thickness of the first metal plate 110. As discussed above, the tool 10 may be inserted into the first metal plate 110 such that it is tilted away from a vertical axis, such as by an angle of between approximately 1°-5°, such as between approximately 1°-3°, or between approximately 1.5°-2.5°, or other suitable angle. In one example, the tool 10 is inserted into the first metal plate 110 at a distance sufficiently far from an edge of the first metal plate 110 and/or any clamp. For example, the pin 20 may be inserted at a distance of between approximately 10-25 mm away from the edge of the first metal plate 110 and/or clamps 360.

The tool 10 is further inserted into the second metal plate 120 to a suitable plunge depth 160 (see FIG. 2), for example between approximately 0.05 mm and approximately 0.15 mm, such as but not limited to between approximately 0.07 mm and approximately 0.12 mm or between approximately 0.08 mm and approximately 0.10 mm. Once the desired plunge depth 160 is achieved, both the rotational speed and the axial force of the tool 10 are increased. For example, once the desired plunge depth 160 is achieved, the initial axial force of the tool 10 can be increased to a second axial force of between approximately 7-25 kN, such as between approximately 10-22 kN, or between approximately 15-21 kN. Similarly, the initial rotational speed of the tool 10 can be increased to a second rotational speed of between approximately 400-600 RPM, such as between approximately 450-550 RPM or between approximately 480-500 RPM. The tool 10 traverses along the first and second metal plates 110, 120 along the weld path 350 in direction 610 (FIG. 6) at a suitable speed, such as for example, between approximately 50-150 mm/min, or between approximately 70-120 mm/min, or between approximately 80-100 mm/min.

Tables 3 and 4 below provide two non-limiting examples of suitable process parameters.

TABLE 3

| Tool | Plunge Depth | | | | |
|---|---|---|---|---|---|
| Rotational | (into Second | Tool | Axial | Traverse | Traverse |
| Speed | Plate 120) | Tilt Angle | Load | Speed | Length |
| 400-600 rpm | 0.05-0.12 mm | 1-3° | 15-25 | 60-120 | 50-1000 |
| | | | kN | mm/min | mm |

TABLE 4

| Tool | Plunge Depth | | | | |
|---|---|---|---|---|---|
| Rotational | (into Second | Tool Tilt | Axial | Traverse | Traverse |
| Speed | Plate 120) | Angle | Load | Speed | Length |
| 480-500 RPM | 0.05-0.07 mm | 2-3° | 20-22 kN | 80-100 | 400-500 |
| | | | | mm/min | mm |

As discussed above, the method may optionally include positioning a heat sink, such as anvil 500, below the first and second metal plates 110, 120 prior to FSW. The method may additionally or alternatively include using a clamping system, such as clamping system 300, to secure the first and second metal plates 110, 120 relative to a fixation surface on which the first and second metal plates 110, 120 are positioned. As discussed above, the method may additionally or alternatively involve using a cooling system (such as one or more cooling nozzles 600) to cool the first and second metal plates 110, 120 as tool 10 traverses along the plates. Once the desired weld length is achieved, the tool 10 is removed from the first and second metal plates 110, 120.

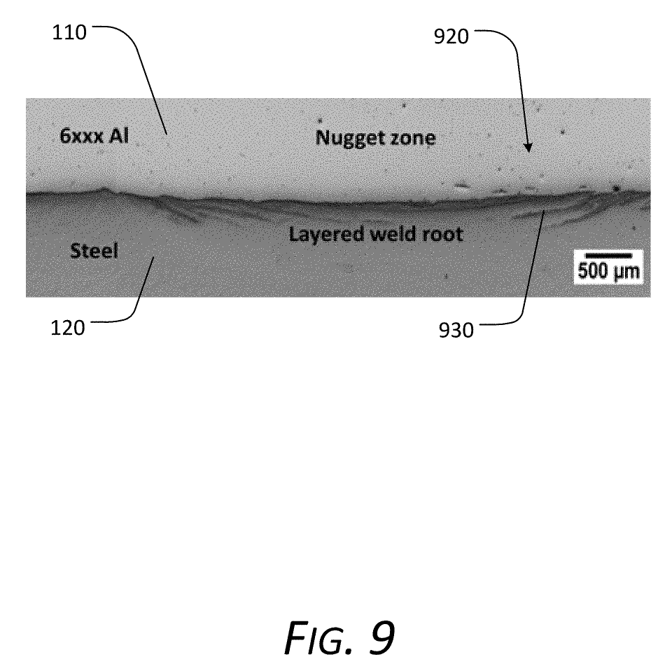

Controlling one or more of the shoulder diameter 25 of the tool 10 (FIG. 1), the pin radius 32 of the tool (FIG. 2) the pin length 28, the traverse speed, the rotational speed, the plunge force and/or the plunge depth of the tool 10 as described above can help reduce the heat generated during FSW. This in turn can help reduce plastic deformation of the first and second metal plates 110, 120 during FSW, which can result in a smaller nugget zone 920 (FIG. 9) within the weld formed by FSW. The nugget zone refers to a distorted zone in the weld that varies in microstructure due to plastic deformation during FSW. In some cases, as shown in FIG. 9, the devices and processes described herein can result in a nugget zone 920 and a layered root 930 in the weld that is smaller than those formed with conventional tools and process parameters. For example, the nugget zone 920 can be approximately equal to or smaller than the tool shoulder and the intermetallic zone at the interface between the first and second metal plates 110, 120 can be less than approximately 2 μm.

An intermetallic zone between the first and second metal plates 110, 120 can be brittle and reduce weld strength. The disclosed process parameters result in a defect-free FSW joint or joint with minimized defects. The disclosed rotational speed and/or traverse speed of the tool 10 in combination with the disclosed plunge force and/or plunge depth helps alleviate or minimize shattering of one or both of first and second metal plates 110, 120 (particularly when second metal plate 120 is steel) in the nugget zone 920 for improved formability and corrosion resistance.

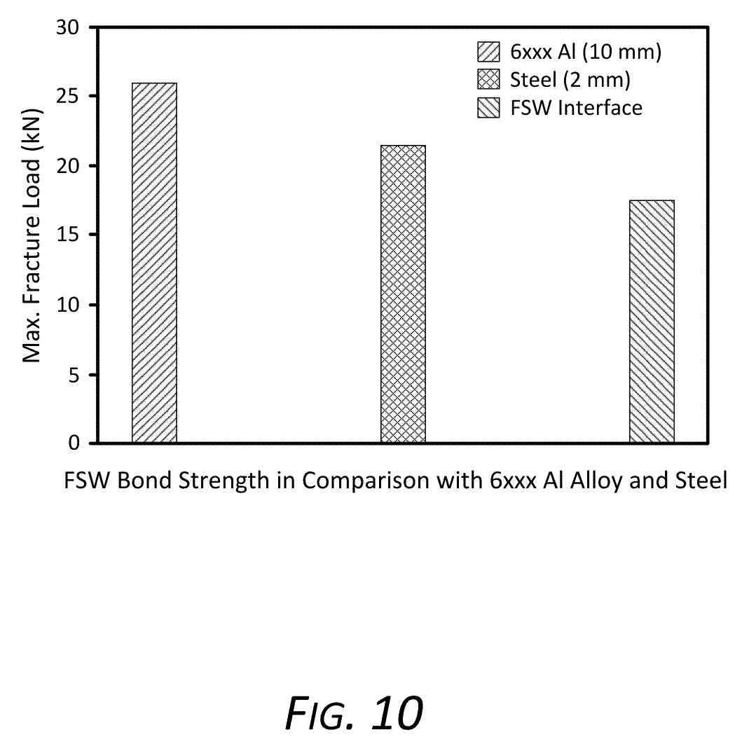

In some cases, the welded first and second metal plates 110 and 120 achieve approximately 60-70% of the strength of the non-welded metal with improved corrosion resistance without disturbing the non-welded metal microstructure. FIG. 10 is a chart illustrating the FSW interface bond strength of the welded first and second metal plates 110, 120 (right bar) as compared with the non-welded (parent) first metal plate 110 (left bar) and second metal plate 120 (middle bar). In this particular case, the first metal plate 110 was a 6xxx aluminum alloy with a thickness of 10 mm and the second metal plate 120 was a steel alloy with a thickness of 2 mm.

Reference has been made in detail to various examples of the disclosed subject matter, one or more examples of which were set forth above. Each example was provided by way of explanation of the subject matter, not limitation thereof. In fact, those skilled in the art will understand that various modifications and variations may be made in the present subject matter without departing from the scope or spirit of the disclosure. For instance, features illustrated or described as part of one example may be used with another example to yield a still further example.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention.

### Example 1

An aluminum plate and a steel plate were friction stir welded using FSW tool 10 made with H13 steel. The aluminum plate and the steel plate were cleaned by scrubbing in acetone with an abrasive pad. The aluminum plate was an AA 5083 alloy with a thickness of 5.82 mm. The steel plate was an AISI 1018 alloy with a thickness of 2.0 mm. The process parameters for welds 1 and 2 are listed in Table 5.

TABLE 5

| | | Plunge Depth | Tool Tilt | | Traverse | Traverse |
|---|---|---|---|---|---|---|
| Weld No. | Tool Rotational Speed | (into Steel Plate) | Angle | Axial Load | Speed | Length |
| 1 | 350 RPM | 0.12 mm | 3° | 24.5 kN | 57 mm/min | 457 mm |
| 2 | 350 RPM | 0.07 mm | 3° | 28 kN | 57 mm/min | 457 mm |

Bar clamps were used to hold the aluminum plate and the steel plate in place. The FSW tool was made of AISI H13 steel (see Table 1). The hardness based on the Rockwell scale was 42 HRC (HRC denotes the metal was indented with a 120° spheroconical diamond with an axial load of 1.47 kN). The pin length of the tool was 5.94 mm, and the pin plunge depth 160 into the steel plate for weld #1 was 0.12 mm. FIG. 4 is a digital image of the result of weld #1. Insufficient vertical restraint led to plate lifting in the center of the weld and surface breaking defects 420 in the last third of weld. Moreover, plate lifting caused the FSW tool to carve the aluminum plate instead of incorporating the aluminum alloy into the weld, resulting in weld flash 400.

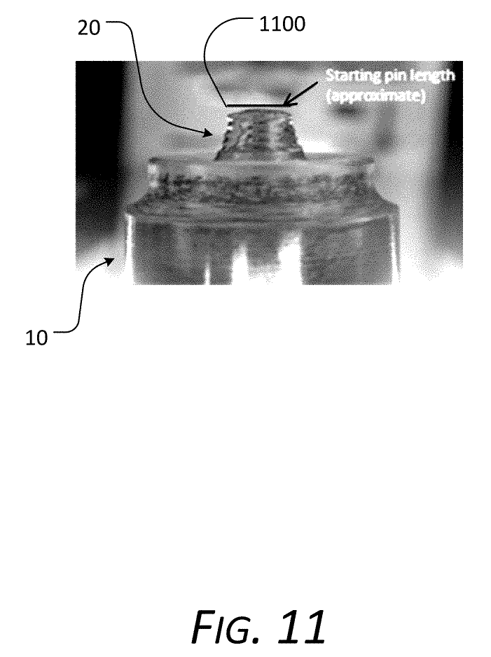

In weld #2, a local clamp was applied to prevent plate lifting, and the pin plunge depth was reduced to 0.07 mm. An air-bag system applied force to rollers adjacent to the FSW tool. Rollers held the work piece in place during the FSW process. Weld #2 was improved but some lifting occurred near the end of the plate, causing flash. The pin tip was worn further and pin length was reduced to 5.82 mm. FIG. 11 shows the extent of the pin deformation 1100. Tool hardness of 42 HRC appeared to be inadequate for hard contact with steel in the FSW process. Tool damage was attributed to mechanical deformation and wear from steel to steel interaction during welding.

### Example 2

Tool 10 was used to friction stir weld an aluminum plate with a steel plate. As Example 1 demonstrated a problem employing a tool made of H13 tool steel in FSW of thicker gauge metals, a FSW tool of M42 tool steel (see Table 1) was used, as the composition provides high hardness. The aluminum plate was an AA 5083 alloy with a thickness of 5.82 mm. The steel plate was an AISI 1018 alloy with a thickness of 2.0 mm. The weld parameters employing the disclosed FSW tool are listed in Table 6.

TABLE 6

| | | Plunge Depth | Tool Tilt | | Traverse | Traverse |
|---|---|---|---|---|---|---|
| Weld No. | Tool Rotational Speed | (into Steel Plate) | Angle | Axial Load | Speed | Length |
| 3 | 600 RPM | 0.03-0.06 mm | 2° | 22.2 kN | 127 mm/min | 457 mm |
| 4 | 525 RPM | 0.03-0.06 mm | 2° | 20.9 kN | 127 mm/min | 457 mm |

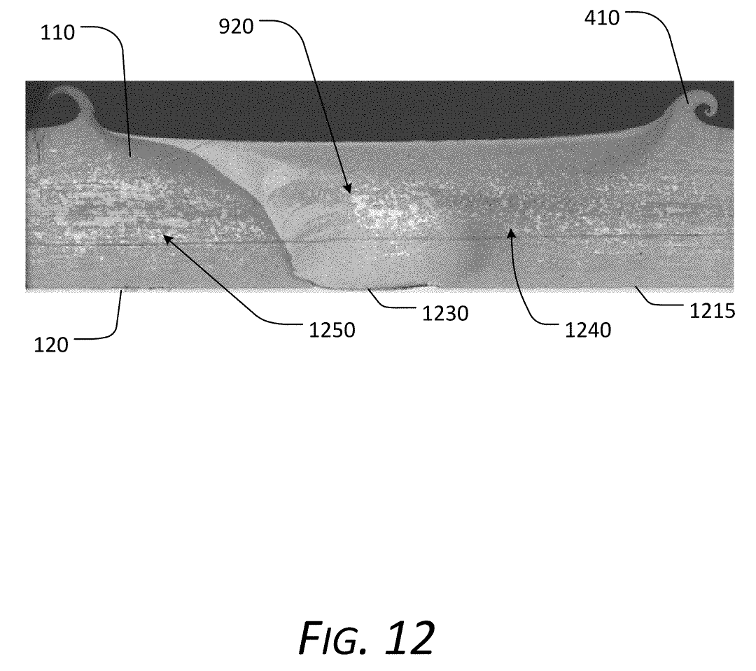

Clamping system 300 using toe clamps 360 described above was applied (see FIG. 3) in weld #3. End clamps 380 were not used. This clamping system was effective at preventing plate lifting during welding. This configuration is suitable for lap configuration FSW. Weld #3 started with the pin 20 of the FSW tool plunged 0.03 mm into the steel plate and at halfway through, the weld plunge depth 160 into the steel plate was increased by 0.03 mm to maintain a constant plunge depth. A moderate amount of flash was observed at the beginning of the weld (plunge depth 160=−0.1 mm), which increased as plunge depth 160 increased (plunge depth 160=0.08 mm). The sample was warped when removed from the fixture. FIG. 12 is a cross-sectional SEM image of weld #3. The aluminum plate 110 and steel plate 120 interface 1215 is shown in FIG. 12. The nugget zone 920 of the weld is evident showing the effect of the stirring. The profile 1230 of the tool 10 can be seen as well in FIG. 12.

Weld #4 employed the same clamping system 300 with toe clamps 360 throughout the weld. The welded plates 110, 120 were allowed to passively cool to ambient temperature while remaining clamped. Weld #4 started with the pin 20 of the FSW tool 10 plunged 0.03 mm into the steel plate (plunge depth 160=−0.12 mm) and at halfway through, the weld plunge depth 160 increased by 0.03 mm (plunge depth 160=−0.25 mm). The welded aluminum and steel plates were left to fully cool in the fixture and loud popping and cracking sounds could be heard as the sample cooled. When removed from the fixture, the welded plates exhibited warping. The weld start and stop points de-bonded between the aluminum and steel plate, showing poor bonding.

### Example 3

Further development of the process for FSW thicker gauge metals is described herein. Three FSW trials were performed to explore the effect of (i) reducing the plunge depth of the pin 20 of the FSW tool 10 by reducing the thickness of the weld path, (ii) stressing the steel plate before FSW and (iii) pre-heating the steel plate before FSW. These modifications helped prevent weld flash and warping. A FSW tool 10 of M42 tool steel (see Table 1) was used. The aluminum plate was an AA 5083 alloy with a thickness of 5.82 mm. The steel plate was an AISI 1018 alloy with a thickness of 2.0 mm. The process parameters for the FSW are listed in Table 7.

TABLE 7

| | | Plunge Depth | Tool Tilt | | Traverse | Traverse |
|---|---|---|---|---|---|---|
| Weld No. | Tool Rotational Speed | (into Steel Plate) | Angle | Axial Load | Speed | Length |
| 5 | 600 RPM | 0.05 mm | 2° | 15.6 kN | 127 mm/min | 457 mm |
| 6 | 600 RPM | 0.05 mm | 2° | 15.8 kN | 127 mm/min | 457 mm |
| 7 | 600 RPM | 0.05 mm | 2° | 17.4 kN | 127 mm/min | 457 mm |

Welding parameters for weld #5 are listed in Table 7. FIG. 7 is a digital image of an aluminum plate 110 with an area of reduced thickness to result in a reduced plunge depth 160 of the pin 20. The weld area 700 of the aluminum plate 110 was thinned from 5.82 mm to 5.61 mm to reduce shoulder contact and flash generation. The plate thickness reduction 700 produced a weld with no flash generation, a smooth weld surface and no wormhole indications in the exit hole.

Welding parameters for weld #6 are listed in Table 7. As shown in FIG. 7, a weld area 700 of the aluminum plate 110 was thinned from 5.82 mm to 5.61 mm to reduce shoulder contact and flash 400 generation. Moreover, as shown in FIG. 8, prior to welding, the steel plate 120 was deformed by a height 800 (in this case, 38 mm) opposite the direction of expected warping during welding. After FSW, the plate was warped to the same level as previous welds with a flat steel plate.

Welding parameters for weld #7 are listed in Table 7. As shown in FIG. 7, a weld area 700 of the aluminum plate 110 was thinned from 5.82 mm to 5.61 mm to reduce shoulder contact and flash generation. Prior to FSW, the steel plate and the fixture surface were preheated to 100° C. to reduce the cooling rate of the weld. During welding, the shoulder 24 of the tool 10 was deeply engaged in the aluminum plate 110 and generated large amounts of flash. A wormhole indication was present in the exit hole.

Decreasing the plunge depth 160 of the pin 20 through plate thinning worked well for reducing the weld flash. Weld loads decreased. Neither pre-stressing nor preheating had an appreciable effect on warping reduction.

### Example 4

Further development of the process for FSW thicker gauge metals is described herein. Four FSW trials were performed to explore the effect of (i) reducing the tool rotational speed and (ii) forced-air cooling during FSW. These modifications helped prevent warping. A FSW tool 10 M42 tool steel (see Table 1) was used. The aluminum plate was an AA 5083 alloy with a thickness of 5.82 mm. The steel plate was an AISI 1018 alloy with a thickness of 2.0 mm. Clamping system 300 was employed applying side clamps 360 and end clamps 380 (see FIG. 3) for the following four welds. The process parameters are listed in Table 8.

TABLE 8

| | | Plunge Depth | Tool Tilt | | Traverse | Traverse |
|---|---|---|---|---|---|---|
| Weld No. | Tool Rotational Speed | (into Steel Plate) | Angle | Axial Load | Speed | Length |
| 8 | 600 RPM | 0.05 mm | 2° | 15.8 kN | 80 mm/min | 457 mm |
| 9 | 500 RPM | 0.15 mm | 2° | 16.1 kN | 80 mm/min | 457 mm |
| 10 | 500 RPM | 0.15 mm | 2° | 16.9 kN | 100 mm/min | 457 mm |
| 11 | 500 RPM | 0.15 mm | 2° | 18.2 kN | 100 mm/min | 457 mm |

Welding parameters for weld #8 are listed in Table 8. As shown in FIG. 7, the thickness of aluminum plate 110 was reduced from 5.82 mm to 5.21 mm in the weld area 700. The pin 20 plunge depth 160 was 0.05 mm. The weld surface was smooth and consistent with no flash. The exit hole showed a small wormhole. As the clamps 360, 380 were removed, the plates 110, 120 separated along the weld path.

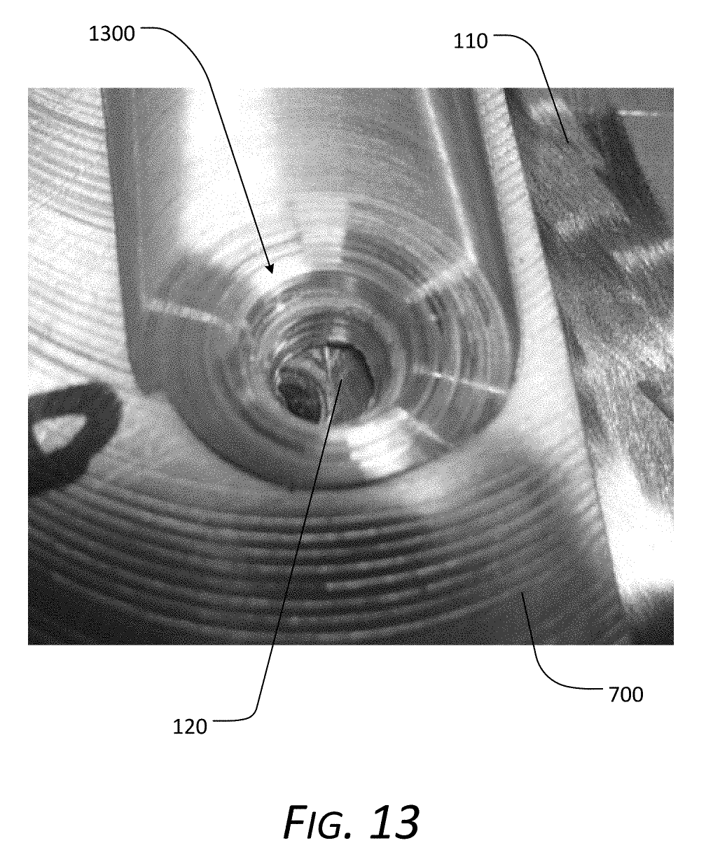

Welding parameters for weld #9 are listed in Table 8. The plunge depth 160 of the pin 20 was increased by 0.1 mm compared to weld #8 to 0.15 mm. The weld surface was smooth and consistent with no flash. As the clamps 360, 380 were removed, the plates 110, 120 de-bonded from the weld exit to a distance 100 mm from the exit hole. The aluminum plate 110 shifted after de-bonding. FIG. 13 is a digital image of the resulting weld, illustrating shifting of the plate in the exit hole 1300 since the exit hole of the steel plate and the aluminum plate are not aligned.

Welding parameters for weld #10 are listed in Table 8. The pin plunge depth 160 into the steel plate was 0.15 mm. The weld surface was smooth and consistent with no flash. As the clamps 360, 380 were removed, the plates remained bonded, but a series of ticking sounds were emitted from the joint line.

Welding parameters for weld #11 are listed in Table 8. A forced air cooling jet, such as nozzle 600 shown in FIG. 6, was added behind the FSW tool 10 to increase cooling. The pin plunge depth 160 into the steel plate was 0.15 mm. The weld surface was smooth and consistent with no flash. No ticking or popping was heard as the work piece was removed from the clamps 360, 380.

Welds #8 and 9 generated the most heat, which may have contributed to the low bond strength. Weld #10, which had a slightly lower heat generation, remained bonded but with suspected local separation. Weld #11 employed forced air cooling and remained bonded with no suspected bondline separation. Increasing the cooling rate of the weld exhibited reduced warping.

### Example 5

Further development of the process for FSW thicker gauge metals is described herein. Four FSW trials were performed to explore the effect of (i) pre-stressing the steel work piece, (ii) cooling with forced air, (iii) cooling with water mist, (iv) lowering the tool rotational speed and (v) increasing the traverse speed during FSW. The modifications prevented warping and steel debris found within the aluminum plate. A FSW tool 10 of M42 tool steel (see Table 1) was used. The aluminum plate was an AA 5083 alloy with a thickness of 5.82 mm. The steel plate was an AISI 1018 alloy with a thickness of 2.0 mm. Clamping system 300 was employed applying side clamps 360 and end clamps 380 (see FIG. 3) for the following four welds. The process parameters are listed in Table 9.

TABLE 9

| | | Plunge Depth | Tool Tilt | | Traverse | Traverse |
|---|---|---|---|---|---|---|
| Weld No. | Tool Rotational Speed | (into Steel Plate) | Angle | Axial Load | Speed | Length |
| 12 | 500 RPM | 0.15 mm | 2° | 18.2 kN | 100 mm/min | 457 mm |
| 13 | 500 RPM | 0.15 mm | 2° | 18.7 kN | 100 mm/min | 457 mm |
| 14 | 480 RPM | 0.15 mm | 2° | 19.4 kN | 120 mm/min | 457 mm |
| 15 | 480 RPM | 0.15 mm | 2° | 18.3 kN | 100 mm/min | 457 mm |

Welding parameters for weld #12 are listed in Table 9. The pin plunge depth 160 into the steel plate was 0.15 mm. The steel plate was pre-stressed (see FIG. 8) to a center height 800 of 46.5 mm over the 508 mm plate length. As the clamps 360, 380 were removed, the plates 110, 120 de-bonded from the weld plunge point and the weld exit point by a distance 150 mm from both the plunge and the exit points. One forced air cooling nozzle, such as nozzle 600 shown in FIG. 6, was used behind the tool 10 to assist in weld cooling, as described above. Compressed air was supplied at 90 psi through a 6.4 mm nozzle.

Welding parameters for weld #13 are listed in Table 9. The pin plunge depth 160 into the steel plate was 0.15 mm. Four water mist cooling nozzles (such as nozzles 600 shown in FIG. 6) were used behind the FSW tool 10 to assist in cooling material during the FSW procedure. As the clamps 360, 380 were removed, there were no noticeable cracking noises from the joint line. The aluminum and steel plates remained very flat upon removal from the fixture surface.

Welding parameters for weld #14 are listed in Table 9. The pin plunge depth 160 into the steel plate was 0.15 mm. No cooling was applied for weld #14. The weld surface was smooth and consistent with no flash. The weld completed without incident. As the clamps 360, 380 were removed, no popping or cracking sounds were emitted.

Welding parameters for weld #15 are listed in Table 9. The pin plunge depth 160 into the steel plate was 0.15 mm. No cooling was applied for weld #14. The weld surface was smooth and consistent with no flash. The weld completed without incident and no popping or cracking sounds were noted upon removal of the clamps 360, 380 and removal from the fixture.

De-bonding occurred when the most heat was generated, internal stresses were greater for weld #12 with the pre-stressed steel plate, and the effective pin tip plunge depth 160 was increased. The increased cooling rate caused by the presence of the water mist behind the FSW tool 10 was extremely effective at reducing the warping caused by the welding process.

### Example 6

Further development of the process for FSW thicker gauge metals is described herein. Two FSW trials were performed to explore the effect of (i) combining findings from previous trials and (ii) employing a copper anvil 500 as a heat sink during FSW. The modifications prevented warping of the aluminum plate and the steel plate. A FSW tool of M42 tool steel (see Table 1) was used. The aluminum plate was an AA 5083 alloy with a thickness of 5.82 mm. The steel plate was an AISI 1018 alloy with a thickness of 2.0 mm. The process parameters are listed in Table 10.

TABLE 10

| | | Plunge Depth | Tool Tilt | | Traverse | Traverse |
|---|---|---|---|---|---|---|
| Weld No. | Tool Rotational Speed | (into Steel Plate) | Angle | Axial Load | Speed | Length |
| 16 | 480 RPM | 0.08 mm | 2° | 21.8 kN | 100 mm/min | 457 mm |
| 17 | 480 RPM | 0.08 mm | 2° | 21.6 kN | 100 mm/min | 457 mm |

The parameters for weld #16 are listed in Table 10. The pin plunge depth 160 into the steel plate was reduced by 0.07 mm to a depth of 0.08 mm compared to weld #15. The weld surface was smooth and consistent with no flash. The weld completed without incident, although light popping sounds were noted while cooling in the fixture.

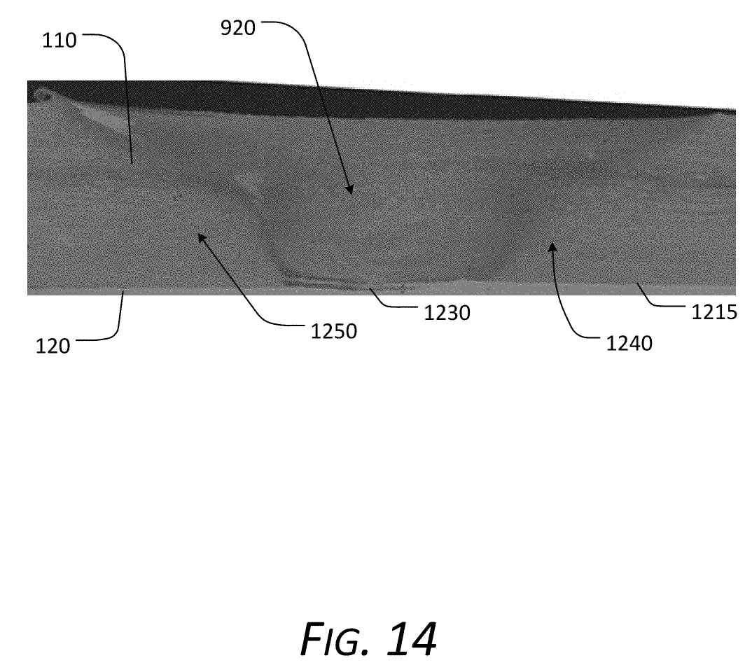

The weld parameters for weld #17 are listed in Table 10. All conditions are identical to weld #16, including the plunge depth 160. The weld surface was smooth and consistent with no flash. The weld completed without incident and no popping or cracking sounds were noted during cooling or upon removal from the fixture. FIG. 14 is a cross-sectional SEM image of weld #17. The aluminum plate 110 and the steel plate 120 interface 1215 is shown. The nugget zone 920 of the weld is evident showing the effect of the stirring. The profile 1230 of the FSW tool 10 can be seen as well.

Slight plastic deformation of the copper anvil 500 occurred after welding for both welds #16-17. Some differences were noted between the welds despite the attempts to maintain identical welding conditions. For example, there was slightly more advancing side material build-up on weld #16, more distortion on weld #16 and a possible wormhole on weld #17.

### Example 7

Further development of the process for FSW thicker gauge metals is described herein. Two FSW trials were performed to explore butt welding aluminum alloy and steel plates using FSW. A FSW tool 10 of M42 tool steel (see Table 1) was used. The aluminum plate was an AA 5083 alloy with a thickness of 5.82 mm. The steel plate was an AISI 1018 alloy with a thickness of 2.0 mm. The process parameters are listed in Table 11.

TABLE 11

| | | Plunge Depth | Tool Tilt | | Traverse | Traverse |
|---|---|---|---|---|---|---|
| Weld No. | Tool Rotational Speed | (into Steel Plate) | Angle | Axial Load | Speed | Length |
| 18 | 480 RPM | 4.85 mm | 0° | 17 kN | 100 mm/min | 450 mm |
| 19 | 480 RPM | 4.85 mm | 2° | 18 kN | 100 mm/min | 450 mm |

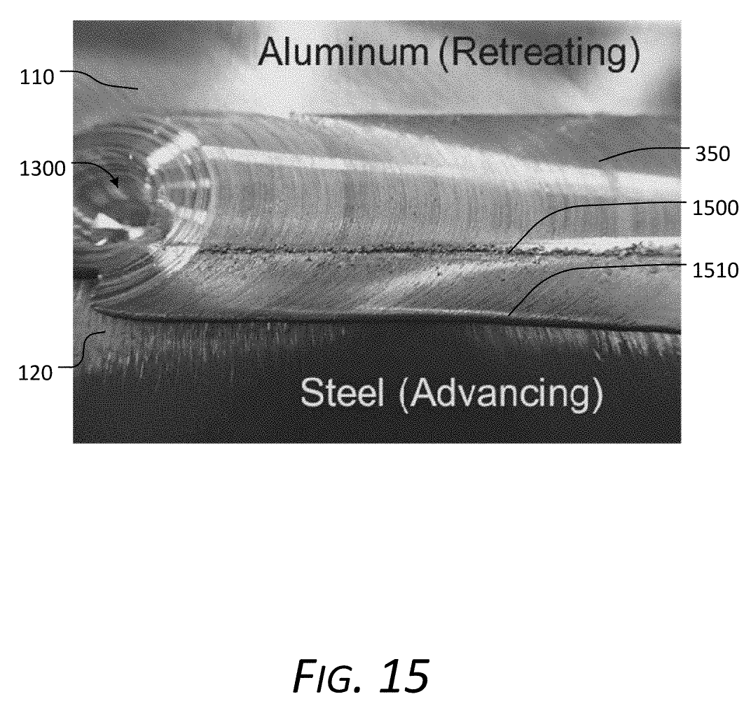

The parameters for weld #18 are listed in Table 11. The reference point for the tool position was the outside edge of the steel plate 120. FIG. 15 is a digital image of the butt-welded metal plates 110, 120. The weld path 350 contained a line 1500 at the joint interface throughout the length of the weld. The advancing side of the weld appears to contain a ribbon of steel 1510 caused by the FSW tool 10 being inserted too far into the steel plate. The exit hole 1300 contains a wormhole type of indication.

The parameters for weld #19 are listed in Table 11. The reference point for the tool position was the outside edge of the steel plate 120. The weld surface contained a line at the joint interface throughout the length of the weld. The exit hole contains a wormhole type of indication. Tool tilt for this weld was 2°. Despite changes to the tool programming, the tool was plunged about 0.7 mm too far into the steel plate (target was 0.2 mm).

### Example 8

Warping, grain structure, hardness, tensile strength and corrosion resistance of the FSW bonded pieces were analyzed for select weld trials.

### Warping

Warping results are presented in Table 12. The amount of warping was measured by placing the welded bond in reference to a flat surface.

TABLE 12

| Weld No. | Aluminum plate (mm) | Steel plate (mm) |
|---|---|---|
| 5 | 9.9 | 9.1 |
| 6 | 11.0 | 8.3 |
| 7 | 12.25 | 12.2 |
| 9 | De-bonded | De-bonded |
| 10 | 8.05 | 8.1 |
| 11 | 7.2 | 6.7 |
| 12 | De-bonded | De-bonded |
| 13 | 2.7 | −2.1 |
| 14 | 7.2 | 4.6 |
| 15 | 7.2 | 4.4 |
| 16 | 6.3 | 5.7 |
| 17 | 5.4 | 4.5 |

### Grain Structure

The grain structure of some of the samples after FSW is presented in FIGS. 12 (weld #3) and 14 (weld #17). The nugget zone 920, thermo-mechanically affected zone 1240 and heat affected zone 1250 are evident.

### SEM

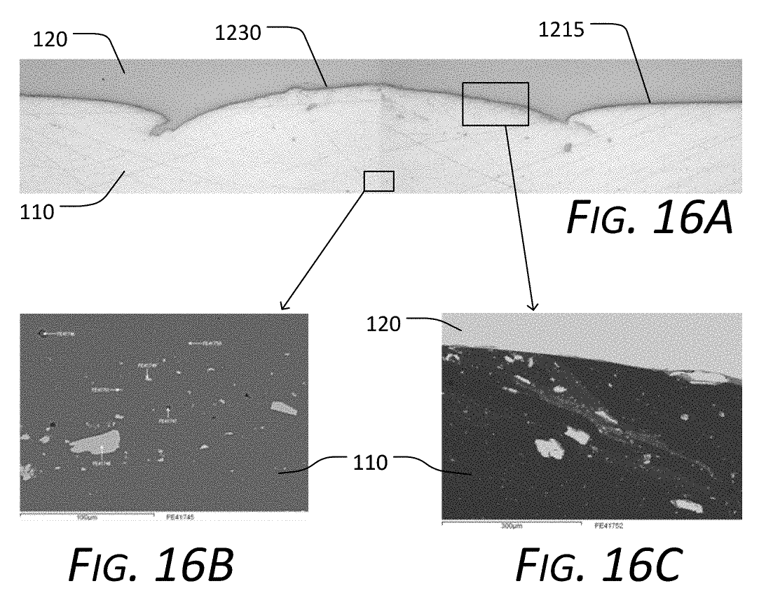

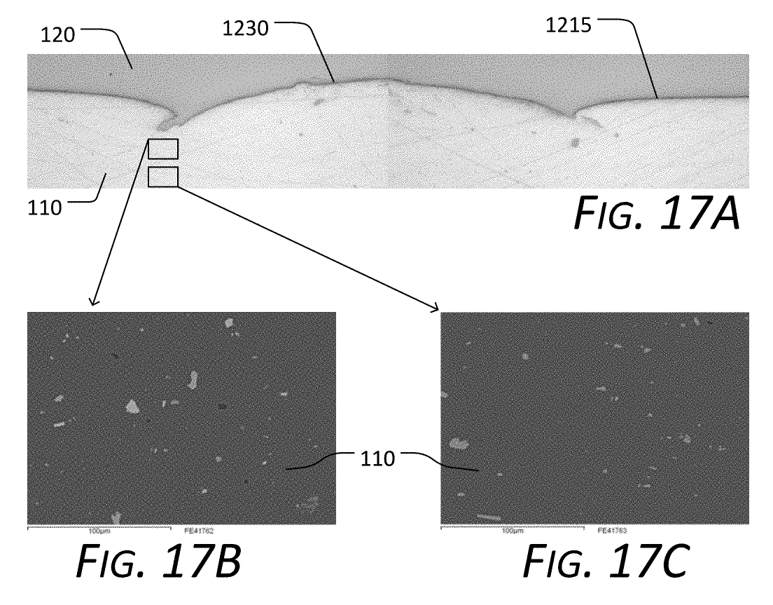

FIGS. 16A-C and FIGS. 17A-C are cross-sectional SEM images of weld #2. The interface 1215 of the aluminum plate 110 and the steel plate 120 is evident in the images. The profile 1230 of the domed tip 30 of the tool 10 is clearly visible.

### Hardness

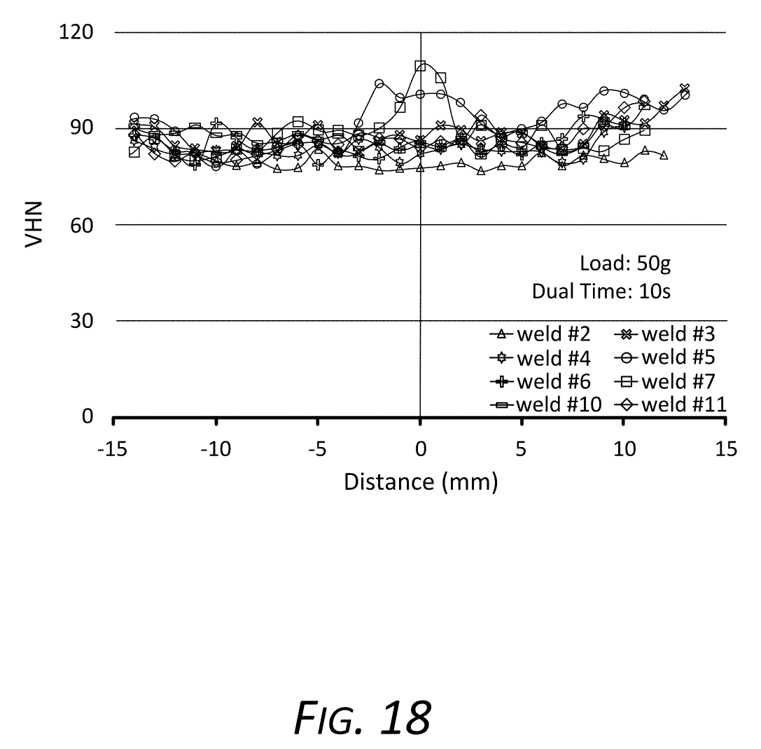

FIG. 18 presents micro-hardness data for welded work pieces from weld #'s 2, 3, 4, 5, 6, 7, 10 and 11. Samples were subjected to a Vickers hardness test. The axial load was 50 g. The duration of the indenting was 10 seconds. The graph shows no change in hardness throughout the weld nugget zone due to the FSW process. FSW is a solid state joining method where parent material retains its integrity and inherent properties. Welds #3 and #5 show some scattered value in the root due to steel shattering.

### Tensile Strength

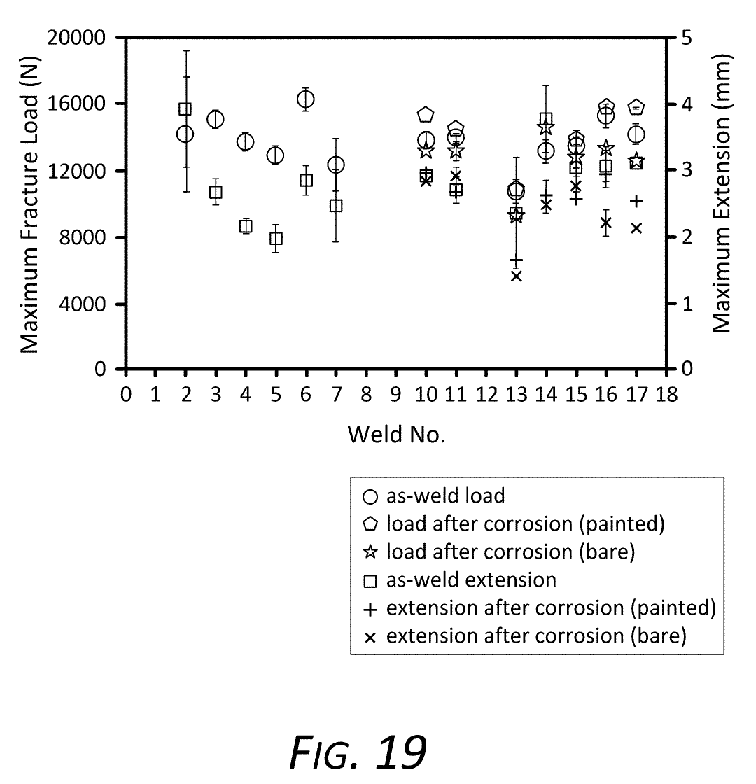

FIG. 19 presents the results of tensile strength testing of weld #'s 2, 3, 4, 5, 6, 7, 10, 11, 13, 14, 15, 16 and 17 before and after exposure to a corrosive environment. Open circles indicate the maximum fracture load (in N) of samples without paint or corrosion. Open squares indicate the extension (in mm) before fracture of samples without paint or corrosion. Open stars indicate the maximum fracture load (in N) of corroded samples without paint. Dark X's indicate the extension (in mm) before fracture of corroded samples without paint. Open pentagons indicate the maximum fracture load (in N) of painted and corroded samples. Dark crosses (+) indicate the extension (in N) before fracture of painted and corroded samples. As shown in FIG. 19, the FSW joint retains joint strength without any degradation even after 500 h exposure to a neutral salt spray. A slight drop in strength was observed for the samples subjected to corrosion in bare (uncoated) condition, however no drop in strength was observed for electrocoated (e-coated) samples.

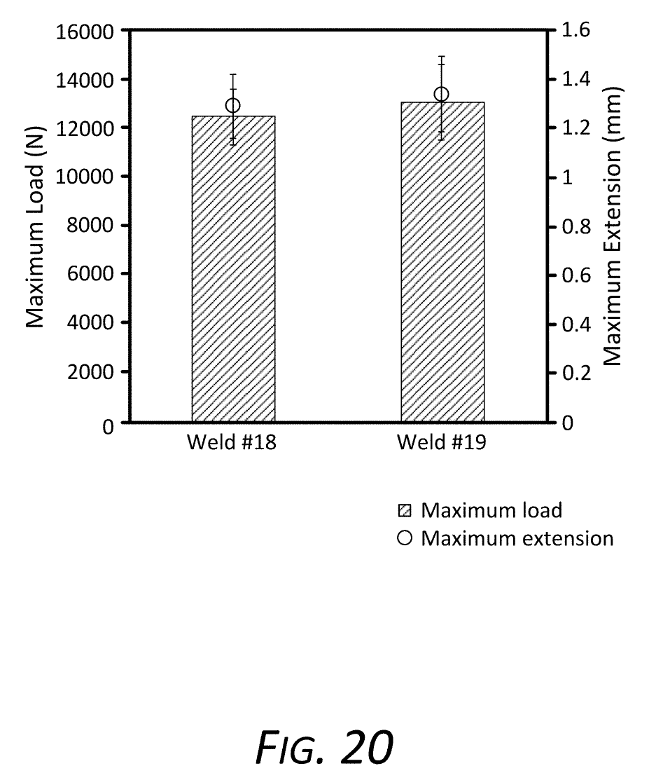

FIG. 20 is a graph of the tensile strength of the butt welded metal plates (welds #18 and #19). Butt welding metal plates using FSW produced a bond weaker than FSW in lap configuration.

### Corrosion

Corrosion resistance of the welded joints was tested according to the ASTM B117 standard. Welded workpieces were exposed to a salt spray for 500 hours. The joints were tested in as received (Bare/without coating) and painted conditions. Cathoguard 500 (supplied by BASF) was applied using the electrocoat (e-coat) method. Before e-coating, the samples were subjected to Zn phosphating with target coat weight of 2.5-3.0 g/m². After 500 hours of testing, the samples were assessed based on the residual mechanical strength by tensile testing and corrosion morphology assessment by metallographic cross section. For comparison purposes, the unexposed bare and painted samples were subjected to tensile testing as well.

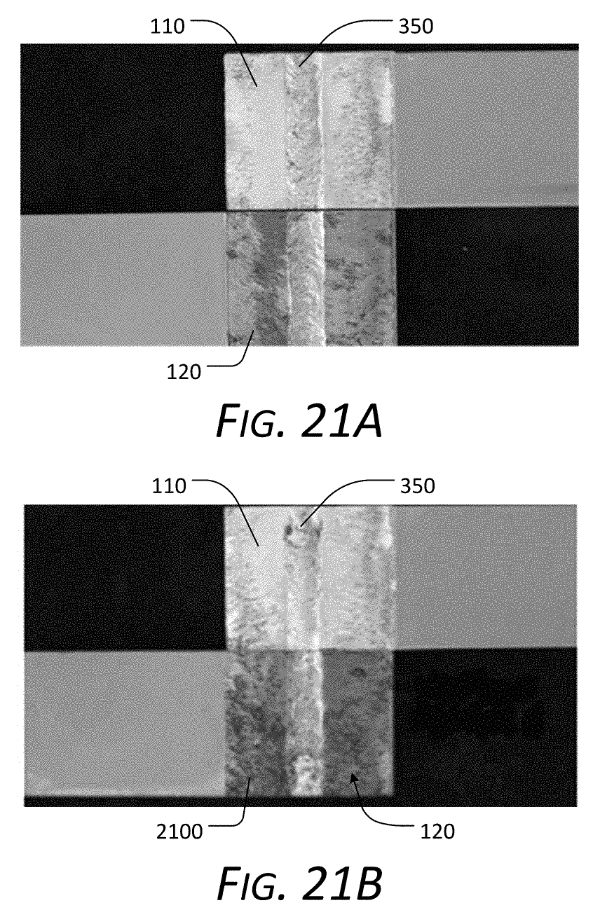

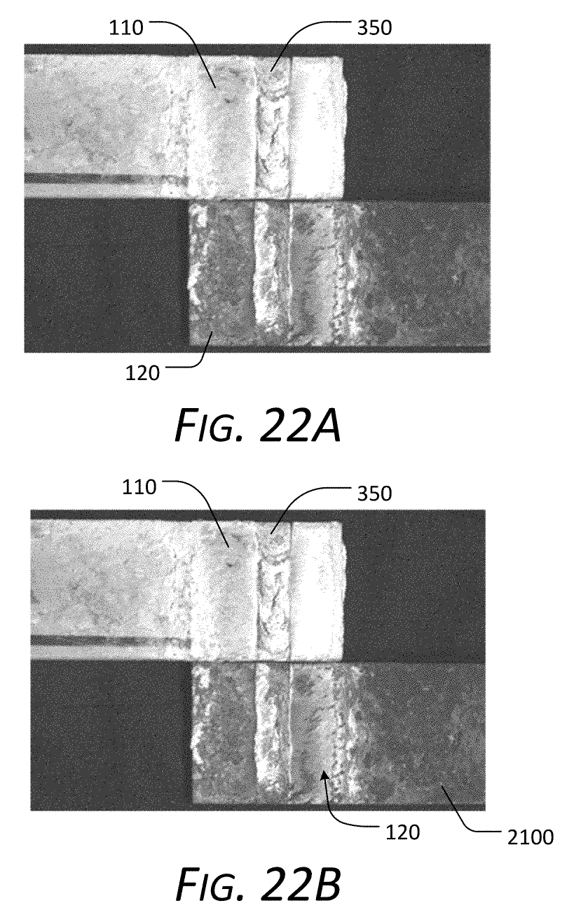

FIGS. 21A-B and FIGS. 22A-B are digital images of the corrosion that occurred in the FSW area at the aluminum—steel interface of samples from weld #17. FIGS. 21A-B show the corrosion test result of coated samples. FIGS. 22A-B show the corrosion test result of samples that were not coated. Overall, the uncoated sample exhibited a higher degree of corrosion 2100. As expected, metallographic cross section showed clear signs of aluminum plate corrosion around the steel in both shattered pieces and the weld area. However, the residual strength of the bare specimens was still very close to the painted samples after 500 hour of salt spray exposure.

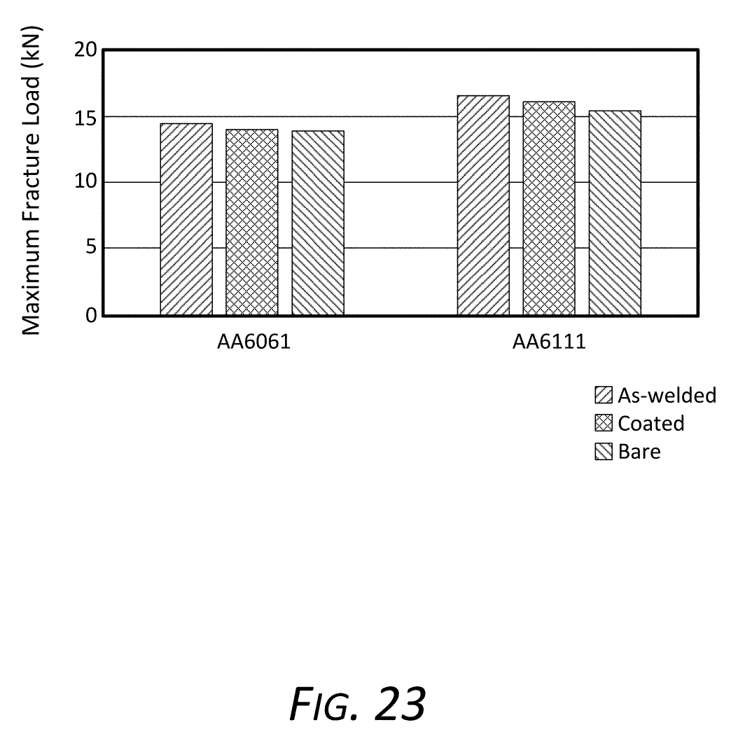

FIG. 23 shows bond strength of AA6xxx series aluminum alloys subjected to a neutral salt spray corrosion test for 500 hours after FSW and optional painting. Two aluminum alloys, AA6061 (left set of histograms) and AA6111 (right set of histograms) were bonded to steel samples. The bonded aluminum-steel samples were cut to provide two test samples. Samples prepared for corrosion testing are summarized in Table 13:

TABLE 13

| Alloy | Preparation | | |
|---|---|---|---|
| AA6061 | As-welded | Bare | Coated |
| AA6111 | As-welded | Bare | Coated |

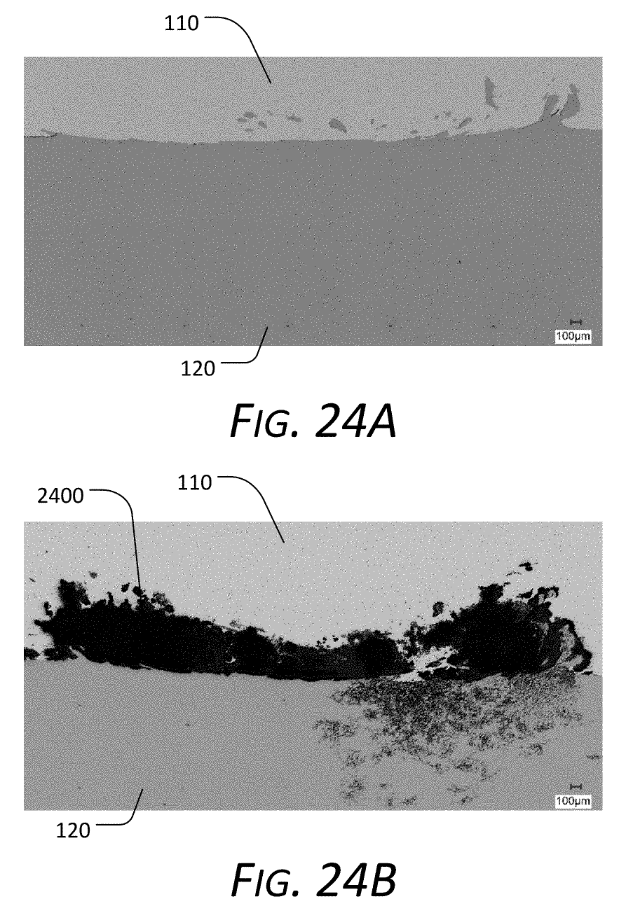

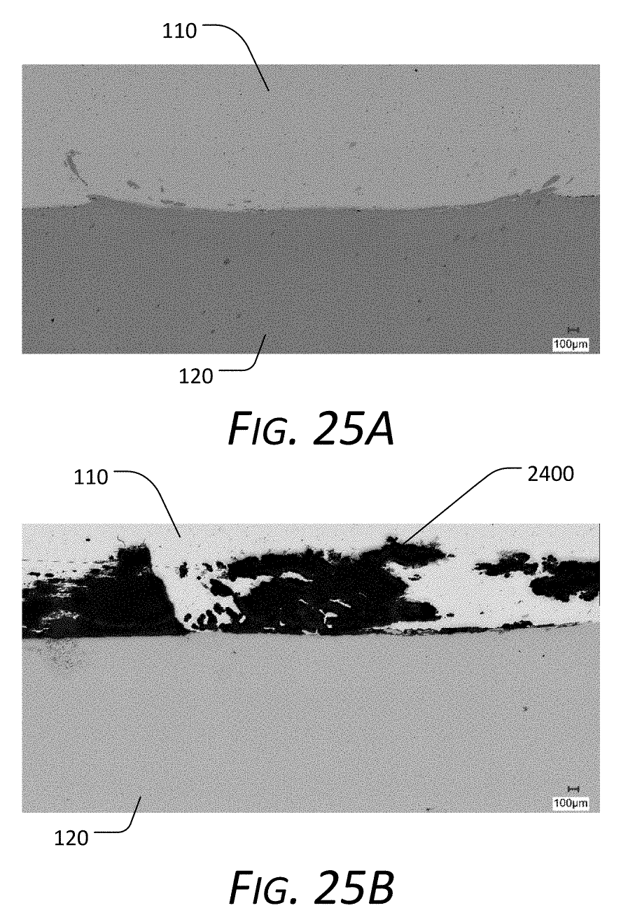

As-welded samples were not subjected to the corrosion test for comparison. Exemplary bare samples were bonded to steel and subjected to the corrosion test. Exemplary coated samples were bonded to steel and coated as described above. For both alloys, corrosion tested samples demonstrated slight decreases in bond strength compared to a non-corroded aluminum-steel FSW sample. FIGS. 24A-B and 25A-B show micrographs of FSW joints after corrosion testing. FIG. 24A shows aluminum alloy AA6061 bonded to steel and coated. Evident in the micrograph is excellent resistance to corrosion in a bonding area (i.e., a FSW joint) of a friction stir welded and coated workpiece. FIG. 24B shows aluminum alloy AA6061 bonded to steel and not coated. Evident in the micrograph is pitting corrosion in the aluminum alloy adjacent to the FSW joint. Also evident is no intergranular corrosion demonstrating the FSW joint can resist intergranular corrosion. FIG. 25A shows aluminum alloy AA6111 bonded to steel and coated. Evident in the micrograph is excellent resistance to corrosion around the FSW joint of a friction stir welded and coated workpiece. FIG. 25B shows aluminum alloy AA6111 bonded to steel and not coated. Evident in the micrograph is pitting corrosion in the aluminum alloy adjacent to the FSW joint. Also evident is no intergranular corrosion demonstrating the FSW joint can resist intergranular corrosion.

### Example 9

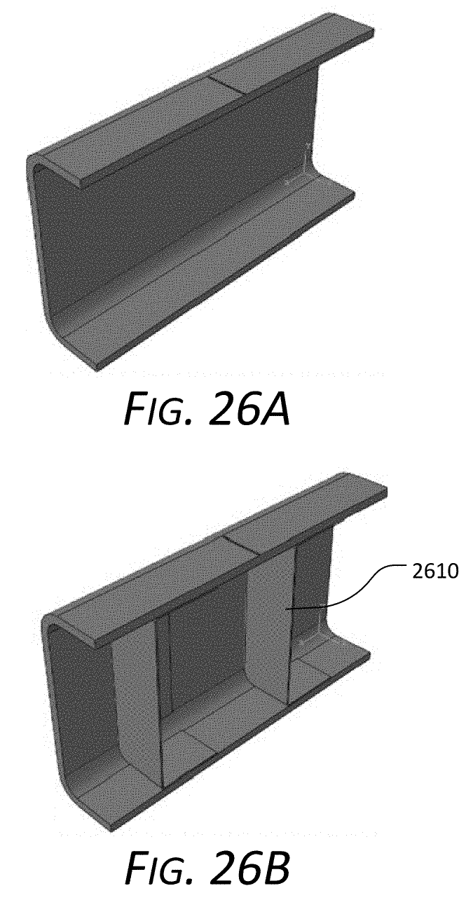

The alloys and methods described herein can be used in automotive and transportation applications, such as commercial vehicle, aircraft, ship building, automotive or railway applications, or other applications. For example, the alloys could be used for chassis, cross-member, and intra-chassis components (encompassing, but not limited to, all components between the two C channels in a commercial vehicle chassis) to achieve strength, serving as a full or partial replacement of high-strength steels. In certain examples, the alloys can be used in O, F, T4, T6x, or T8x tempers. In certain aspects, the alloys are used with a stiffener or insert to provide additional strength. FIG. 26A shows a perspective view of a frame rail that can be provided according to methods described herein. FIG. 26B shows a perspective view of a frame rail containing stiffeners 2610 that can be provided according to methods described herein. Stiffeners can be an aluminum alloy, steel, any combination thereof, or any suitable metal (e.g., nickel, copper, etc.) that can increase stiffness of the frame rail. Adding stiffeners to the frame rail can increase the stiffness of the frame rail up to about 80% (e.g., the frame rail is 80% more resistant to bending and torsion than a frame rail without stiffeners).

In certain aspects, the alloys and methods can be used to prepare motor vehicle body part products. For example, the disclosed alloys and methods can be used to prepare automobile body parts, such as bumper beams, side beams, roof beams, cross beams, pillar reinforcements (e.g., A-pillars, B-pillars, and C-pillars), inner panels, side panels, floor panels, tunnels, structure panels, reinforcement panels, inner hoods, or trunk lid panels. The disclosed aluminum alloys and methods can also be used in aircraft, ship building or railway vehicle applications, to prepare, for example, external and internal panels. In certain aspects, the disclosed alloys can be used for other applications, such as automotive battery plates/shates and wiring chases.

What is claimed is:

1. A method of friction stir welding comprising:
positioning a first metal plate adjacent a second metal plate, wherein the first metal plate is an aluminum plate with a thickness of between approximately 5 mm and approximately 10 mm and wherein the second metal plate comprises a steel plate, a copper plate, a nickel plate, or any other suitable metal plate with a thickness less than the thickness of the first metal plate;
rotating a friction stir welding tool at an initial rotational speed of between approximately 50 RPM and approximately 150 RPM;
tilting the friction stir welding tool at a desired angle from a vertical axis, wherein the desired angle is between 1°-5°;
applying an initial axial load of between approximately 7 kN and approximately 15 kN to cause a tip of the friction stir welding tool to penetrate the first metal plate through the thickness of the first metal plate and partially penetrate the second metal plate by a plunge depth;
increasing the initial rotational speed of the friction stir welding tool to a second rotational speed, wherein the second rotational speed is between approximately 400 RPM and approximately 600 RPM;
increasing the initial axial load of the friction stir welding tool to a second axial load of between approximately 15 kN and approximately 25 kN; and
traversing the friction stir welding tool along a weld path of the first metal plate.

2. The method of claim 1, further comprising:
positioning the second metal plate directly on a copper heat sink; and
traversing at least one cooling nozzle behind the traversing friction stir welding tool to cool the first metal plate, wherein:
the initial axial load is approximately 7 kN;
the desired angle is between 2°-3°;
the initial rotational speed is approximately 100 RPM;
the second axial load is between approximately 20 kN and approximately 22 kN;
and
the second rotational speed is between approximately 480 RPM and approximately 500 RPM.

3. The method of claim 1, wherein the plunge depth is between approximately 0.05 mm and approximately 0.12 mm.

4. The method of claim 1, wherein the plunge depth is between approximately 0.05 mm and approximately 0.07 mm.

5. The method of claim 1, wherein the friction stir welding tool comprises a shoulder and a pin, wherein the shoulder comprises a shoulder surface, wherein the shoulder surface is a concave surface, and wherein the pin extends from the shoulder surface;

6. The method of claim 1, wherein the friction stir welding tool traverses the weld path at a speed between approximately 50 mm/min and approximately 150 mm/min.

7. The method of claim 1, wherein the friction stir welding tool traverses the weld path for a distance between approximately 50 mm and approximately 1000 mm.

8. The method of claim 1, wherein the tip of the friction stir welding tool penetrates the first metal plate at a distance between approximately 10 mm and approximately 25 mm away from an edge of the first metal plate.

9. The method of claim 1, further comprising traversing a cooling system behind the traversing friction stir welding tool to cool at least the first metal plate or the second metal plate.

10. The method of claim 9, wherein the cooling system comprises at least one cooling nozzle or a copper heat sink.

11. The method of claim 1, further comprising reducing the thickness of at least the first metal plate or the second metal plate along at least a portion of the weld path before applying the initial axial load.

12. The method of claim 11, wherein between approximately 0.05 mm and approximately 0.5 mm of the thickness of at least the first metal plate or the second metal plate is reduced.

13. The method of claim 1, wherein the first metal plate has a first plane adjacent to a first face or the second metal plate has a second plane adjacent to a second face and the method further comprises apply a force to the first metal plate or the second metal plate to cause the first face to extend away from the first plane or the second face to extend away from the second plane.

14. The method of claim 13, wherein the first face extends away from the first plane or the second face extends away from the second plane at a distance between approximately 1 mm and approximately 100 mm.

15. The method of claim 1, wherein a portion of the first metal plate overlaps with a portion of the second metal plate by a distance between approximately 1 mm and approximately 25 mm.

16. The method of claim 1, further comprising bonding the first metal plate and the second metal plate before applying an initial axial load to penetrate the first metal plate.

17. The method of claim 16, wherein the first metal plate and the second metal plate are bonded using one of welding or adhesives.

18. The method of claim 1, further comprising clamping an edge of the first metal plate or the second metal plate to prevent movement of the first metal plate or second metal plate when applying the axial load.

19. The method of claim 1, further comprising preparing a first face of the first metal plate or a second face of a second metal plate by cleaning the first face or the second face.

20. The method of claim 19, wherein the first face or the second face is cleaned by an abrasive pad or a solvent.
